(19) United States
(12) Patent Application Publication
(10) Pub. No.: US 2026/0317232 A1
(43) Pub. Date: Oct. 15, 2026

(54) Joint Compound Additive

(71) Applicant: Muddskip LLC, Colleyville, TX (US)

(72) Inventor: Sheila Cross, Colleyville, TX (US)

(73) Assignee: Muddskip LLC, Colleyville, TX (US)

(21) Appl. No.: 19/641,877

(22) Filed: Apr. 8, 2026

Related U.S. Application Data
(60) Provisional application No. 63/788,950, filed on Apr. 15, 2025.

(51) Int. Cl. C04B 14/22; C04B 14/04; C04B 14/10; C04B 14/18; C04B 14/20; C04B 14/28; C04B 14/30; C04B 16/04; C04B 28/14; C04B 111/00; C04B 111/20

(52) U.S. Cl. CPC C04B 14/22; C04B 14/042; C04B 14/102; C04B 14/104; C04B 14/18; C04B 14/20; C04B 14/28; C04B 14/303; C04B 14/304; C04B 14/305; C04B 14/308; C04B 16/04; C04B 28/14; C04B 2111/00681; C04B 2111/2092

(57) ABSTRACT

A joint compound additive is provided. The additive can be mixed with an existing joint compound to initiate a chemical transformation that imparts microbial resistance, improved application characteristics, and environmental safety to the joint compound. Upon mixing with a base joint compound, the additive initiates a transformation that inhibits microbial colonization and resists contamination from airborne particles and impure substances. The modified joint compound achieves smooth and uniform consistency, facilitating enhanced tool glide, improved spreadability, and reduced particulate release during application. The additive further enables multi-layer applications of the joint compound without requiring full drying or surface abrasion. The resulting mixture supports rehydration and increases compound longevity.

### CROSS-REFERENCE TO RELATED APPLICATION

The present application claims priority to, and the benefit of, U.S. Provisional Application No. 63/788,950, which was filed on Apr. 15, 2025, and is incorporated herein by reference in its entirety.

### FIELD OF THE INVENTION

The present invention relates generally to the field of joint compounds. More specifically, the present invention relates to an additive that can be mixed with an existing joint compound when mixed by initiating a chemical transformation that imparts microbial resistance, enhanced application properties, and environmental safety to the joint compound. Accordingly, the present disclosure makes specific reference thereto. Nonetheless, it is to be appreciated that aspects of the present invention are also equally applicable to other like applications, devices, and methods of manufacture.

### BACKGROUND

Moisture intrusion in wall and ceiling assemblies remains a persistent issue in both residential and commercial construction. When moisture permeates these surfaces, it often interacts with joint compounds that lack sufficient microbial resistance. Conventional joint compounds are vulnerable to contamination from environmental sources such as ambient air, unsanitized tools, and impure water. These contaminants can lead to the formation of mold and mildew spores within the compound. Over time, these spores can proliferate on the surface of walls and ceilings, resulting in structural damage and health risks for building occupants. Mold exposure can aggravate respiratory conditions and contribute to long-term health hazards, particularly in environments with poor ventilation. The absence of antimicrobial agents within standard joint compounds contributes to compound degradation and reduced durability. Moreover, once spores are introduced into the joint compound, they may be transferred directly onto surfaces, further accelerating mold growth. This creates a compounding problem that affects both construction integrity and occupant safety. As a result, there is a clear and ongoing need to stabilize joint compounds through the incorporation of effective additives that mitigate microbial growth while supporting efficient application.

Therefore, there exists a long-felt need in the art for a joint compound additive that prevents mold and mildew formation within and on applied compound surfaces when mixed with a joint compound. There also exists a long-felt need in the art for a joint compound additive that enables contractors to apply wet-on-wet layers without the need for sanding between coats when mixed with a joint compound. Moreover, there exists a long-felt need in the art for a joint compound additive that enhances compound stability and reduces volatile organic compound emissions for safer use in enclosed environments when mixed with a joint compound.

The subject matter disclosed and claimed herein, in one embodiment thereof, comprises a joint compound additive. The additive can be mixed with an existing joint compound to initiate a chemical transformation that imparts microbial resistance, improved application characteristics, and environmental safety to the joint compound. The additive comprises fractured metal oxide functioning as a micro-abrasive and stabilizing agent, glass particles ranging from approximately 100 to 320 mesh serving as spacing agents for internal flow optimization, and catalyzed quick-set joint compound powder acting as a reactive agent to accelerate bonding and chemical stabilization. Upon mixing with a base joint compound, the additive initiates a transformation that inhibits microbial colonization and resists contamination from airborne particles and impure substances. The modified joint compound achieves smooth and uniform consistency, facilitating enhanced tool glide, improved spreadability, and reduced particulate release during application. The additive further enables multi-layer applications of the joint compound without requiring full drying or surface abrasion, allowing rapid sequential coats during a single work session. The resulting mixture supports rehydration, increases compound longevity, and produces a finish that complies with indoor air quality standards by minimizing volatile organic compound emissions.

In this manner, the joint compound additive of the present invention accomplishes all the foregoing objectives and improves existing joint compounds by providing reduced risk of microbial contamination, a more efficient application processes, and increased environmental safety. Through the combination of fractured metal oxide, glass, and catalyzed quick-set powder, the additive enhances microbial resistance, permits wet-on-wet layering without sanding, and reduces harmful emissions, thereby supporting safe and efficient construction practices. The joint compound additive thus provides a practical and technically robust solution to longstanding challenges in wall and ceiling finishing applications.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a joint compound additive. The additive is configured for introduction into a joint compound to initiate a chemical transformation that improves microbial resistance, application behavior, reusability, and environmental safety of the joint compound. This transformation is achieved through the interaction of three primary components that deliver stabilization and enhanced performance not present in untreated joint compounds.

One embodiment of the additive is comprised of fractured metal oxide functioning as a micro-abrasive and stabilizer, glass acting as spacing agents to improve flow consistency, and catalyzed quick-set joint compound powder serving as a reactive setting agent to accelerate bonding and stabilization.

The additive may be introduced into commercially available joint compounds packaged in various formats. Upon mixing, a chemical reaction is initiated that alters the material properties of the joint compound, providing resistance to microbial growth, mold, and odor while enhancing durability in both sealed and open conditions.

In addition to microbial stabilization, the additive improves the texture and spreadability of the joint compound, resulting in enhanced tool glide and flow through application equipment. The additive further enables rehydration and multi-layer application of the joint compound. After partial drying, the compound remains receptive to new layers without detachment or surface damage, allowing wet-on-wet application and reducing project time. Sanding is not required between coats due to the smooth curing profile, contributing to cleaner environments and reduced labor. The additive also emits low or negligible levels of volatile organic compounds, supporting safe use in enclosed environments without the need for specialized ventilation or protective gear.

The invention further comprises a method of use wherein the additive, comprised of fractured metal oxide, glass, and catalyzed quick-set joint compound powder, is provided, introduced into a joint compound, and mixed to initiate a transformation that improves performance. The stabilized joint compound is then applied in one or more layers, with optional rehydration and without sanding between coats, and is cured under ambient conditions to yield a smooth, uniform finish with minimal particulate release and no VOC-related health hazards.

Accordingly, the joint compound additive of the present invention is particularly advantageous as it improves existing joint compounds by providing reduced risk of microbial contamination, a more efficient application processes, and increased environmental safety. Through the combination of fractured metal oxide, glass, and catalyzed quick-set powder, the additive enhances microbial resistance, permits wet-on-wet layering without sanding, and reduces harmful emissions, thereby supporting safe and efficient construction practices. The joint compound additive thus provides a practical and technically robust solution to longstanding challenges in wall and ceiling finishing applications.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a graphical view of components of an additive of one potential embodiment of a joint compound additive of the present invention in accordance with the disclosed architecture;

FIG. 2 illustrates a graphical view of components of a joint compound of one potential embodiment of a joint compound additive of the present invention in accordance with the disclosed architecture; and

FIG. 3 illustrates a flowchart of a method of using one potential embodiment of a joint compound additive of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a joint compound additive that prevents mold and mildew formation within and on applied compound surfaces when mixed with a joint compound. There also exists a long-felt need in the art for a joint compound additive that enables contractors to apply wet-on-wet layers without the need for sanding between coats when mixed with a joint compound. Moreover, there exists a long-felt need in the art for a joint compound additive that enhances compound stability and reduces volatile organic compound emissions for safer use in enclosed environments when mixed with a joint compound.

The present invention, in one exemplary embodiment, is comprised of a joint compound additive. The additive is designed to be incorporated into a joint compound, where the additive initiates a chemical transformation that enhances the joint compound's microbial resistance, application characteristics, reusability, and environmental safety. This transformation results from the interaction of three principal components, which collectively enable material stabilization and performance improvements not attainable with untreated joint compounds.

In one embodiment, the additive is comprised of fractured metal oxide, which functions as both a micro-abrasive and stabilizer; glass, which act as spacing agents to optimize internal flow consistency; and catalyzed quick-set joint compound powder, which serves as a reactive agent that accelerates bonding and stabilization.

The additive may be added to commercially available joint compounds packaged in boxes, buckets, or bags. When mixed, the components of the additive initiate a chemical reaction that alters the physical properties of the joint compound, enhancing resistance to microbial growth, mold formation, and odor development, while improving durability in both sealed and open environments.

Beyond microbial resistance, the additive modifies the consistency of the joint compound, producing a smoother and more uniform spreadability that improves tool glide and flow behavior during application. The additive further facilitates rehydration and multi-coat application. Once partially dried, the joint compound remains suitable for subsequent layers without detachment or surface damage, allowing for efficient wet-on-wet application and reducing overall project duration. The curing process results in a smooth finish that eliminates the need for sanding between coats, contributing to a cleaner workspace and reduced labor effort. Additionally, the additive emits minimal or negligible volatile organic compounds, enabling its safe use in enclosed spaces without requiring specialized ventilation or protective measures.

The invention also includes a method for using the additive. The process begins with providing a formulation comprised of fractured metal oxide, glass, and catalyzed quick-set joint compound powder. This formulation is then introduced into a joint compound and thoroughly mixed to trigger the transformation that enhances the compound's performance. The stabilized joint compound is applied in one or more layers, with rehydration allowed between coats if needed, and no sanding required. The surface is then cured under ambient conditions, resulting in a uniform, smooth finish with minimal airborne particulates and no VOC-related health concerns.

As a result, the joint compound additive disclosed in the present invention provides significant improvements over conventional joint compounds by reducing microbial contamination risks, increasing application efficiency, and enhancing environmental safety. Through the integration of fractured metal oxide, glass, and catalyzed quick-set powder, the additive enables microbial resistance, supports multi-layer application without sanding, and minimizes emissions, offering a practical and technically advanced solution for wall and ceiling finishing applications.

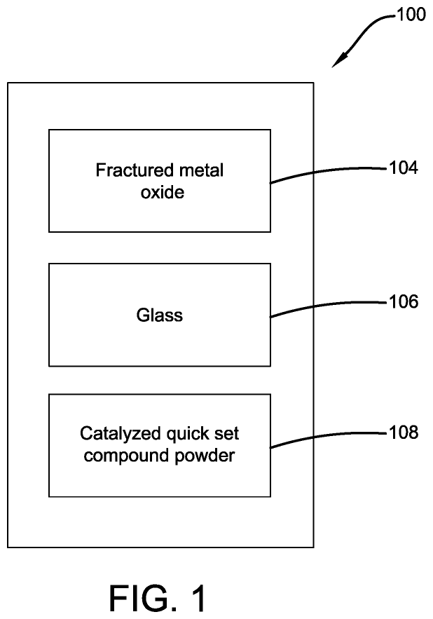

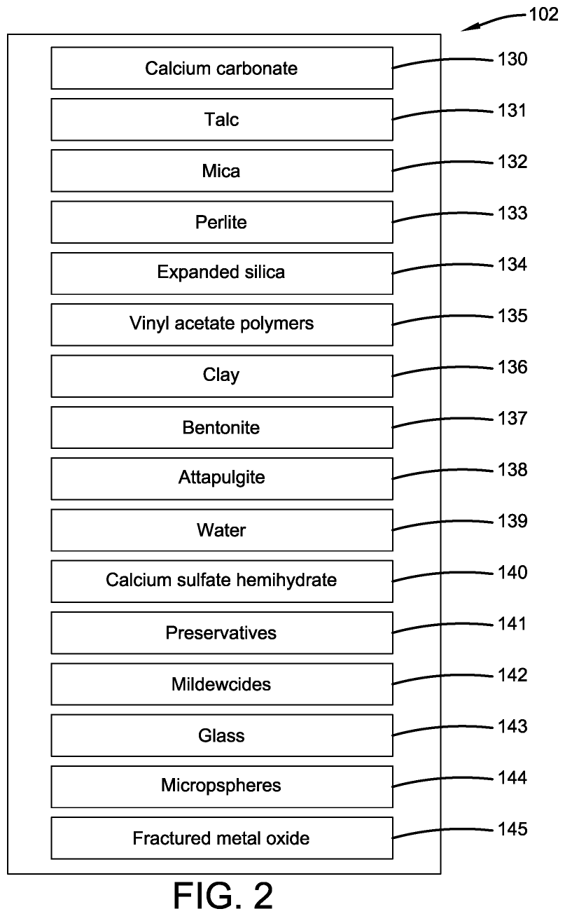

Referring initially to the drawings, FIG. 1 illustrates a graphical view of components of an additive 100 of one potential embodiment of a joint compound additive 100 of the present invention in accordance with the disclosed architecture. The additive 100 is configured to be introduced into an existing spreadable compound 102 such as but not limited to joint compounds, concrete, stucco, spray-texture, spray-compound, paint, etc. to initiate a chemical transformation that enhances the spreadable compound 102 in terms of microbial resistance, application properties, reusability, and environmental safety. The transformation is triggered by the interaction of three primary components of the additive 100, which function to deliver a stabilization mechanism and material performance upgrade not found in untreated joint compounds 102. The spreadable compound 102 may be comprised of but is not limited to a combination of two or more of the following, as seen in FIG. 2: calcium carbonate 130, talc 131, mica 132, perlite 133, expanded silica 134, vinyl acetate polymers 135, clay 136, bentonite 137, attapulgite 138, water 139, calcium sulfate hemihydrate 140, preservatives 141, mildewcides 142, glass 106, microspheres 144, fractured metal oxide 104, or any combination thereof.

In one embodiment, the additive 100 may be comprised of fractured metal oxide 104 that functions as a micro-abrasive particle and chemical stabilizer, glass 106 ranging in mesh size from approximately (but not limited to) 150 to 170 functioning as a spacing agent to enhance internal flow dynamics and consistency, and catalyzed quick-set joint compound powder 108 functioning as a reactive setting agent that accelerates chemical bonding and stabilization processes.

The fractured metal oxide 104 may be various metal oxide types such as but not limited to fractured aluminum oxide, fractured magnesium oxide, fractured, titanium oxide, fractured iron oxide, etc. The glass 106 may be in various forms such as glass beads, crushed glass, ground glass, hollow glass microspheres, glass flakes, etc. In a further embodiment, the additive 100 comprises mineral aggregates 146. The mineral aggregates may be in the form of but not limited to granite, crushed granite, powdered granite, garnet, crushed garnet, powdered garnet, or any other type of

In one formulation, the additive 100 may be prepared in the following proportions by weight: between . 5 and 40 ounces of fractured metal oxide 104, between . 5 and 40 ounces of glass bead 106, and between . 5 and 40 ounces of catalyzed quick-set joint compound powder 108. However, the ratio and weight of components 104, 106, and 108 may be varied depending on the desired performance characteristics or environmental conditions.

The additive 100 may be introduced into any commercially available spreadable compound 102, such as but not limited to joint compounds packaged in boxes, buckets, or bags. Upon mixing, the additive 100 initiates an immediate and active chemical reaction that alters the material behavior of the spreadable compound 102. This transformation inhibits microbial colonization, mildew formation, and chemical spoilage, particularly in the presence of environmental contaminants such as airborne particles, impure water, or unsanitized tools. The additive 100 further creates inherent antimicrobial resistance for the spreadable compound 102, effectively eliminating mold growth, odor development, and structural degradation. The result is a stabilized spreadable compound 102 with enhanced longevity and hygienic properties in both sealed and open environments.

In addition to its microbial stabilization effects, the additive 100 modifies the behavior of the spreadable compound 102. Upon mixing, the consistency of the spreadable compound 102 becomes smoother, softer, and more uniformly spreadable. This enhances tool glide performance and improves flow behavior through application equipment.

The additive 100 further enables the spreadable compound 102 to support rehydration and multi-coat application. After partial drying, the compound 102 remains receptive to additional layers without tearing, peeling away, or delamination from an applied surface. This enables multiple layers of spreadable compound 102 to be applied in rapid succession during a single work period. The ability to apply wet-on-wet layers reduces project completion time by 50 percent or more, depending on environmental factors and user technique. A further advantage of the additive 100 is the elimination of sanding. Due to the compound's 102 smooth curing profile, each applied layer does not require abrasion prior to additional coats or final finishing. This contributes to cleaner worksites, reduced labor, and minimized airborne particulate matter.

The additive 100 is configured to emit low or negligible levels of volatile organic compounds (VOCs), thereby ensuring compliance with indoor air quality standards. The stabilized spreadable compound 102 may be used in enclosed environments without requiring extensive ventilation or protective equipment, supporting continuous workflow and reducing site preparation time.

In alternate embodiments, the additive 100 may be applied in configurations beyond standard joint compound augmentation. Such embodiments include but are not limited to inclusion in sprayable coatings deployed via airless sprayers for uniform wall or ceiling coverage, pre-application to wallboard, cement board, or drywall panels as a factory-applied finish layer, and use as a mold-resistant spray treatment for substrates such as ceiling tiles, gypsum panels, cementitious boards, and other construction surfaces.

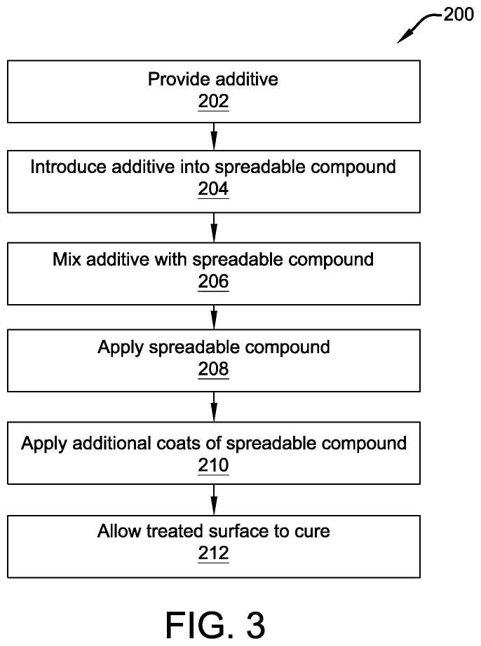

The present invention is also comprised of a method of using 200 the additive 100, as seen in FIG. 3. First, an additive 100 is provided comprised of fractured metal oxide 104, glass bead 106, and catalyzed quick-set joint compound powder 108 [Step 202]. Then, the additive 100 is introduced into an existing spreadable compound 102, wherein the spreadable compound 102 may be contained in a box, bucket, or bag [Step 204]. Next, the additive 100 is thoroughly mixed with the spreadable compound 102 to initiate a chemical transformation that imparts antimicrobial resistance, improved application behavior, and enhanced environmental performance to the spreadable compound 102 [Step 206]. The resulting stabilized spreadable compound 102 is then applied to a surface in one or more layers using standard application tools or equipment, with optional use of rehydration techniques between layers [Step 208]. Subsequently, additional coats of the stabilized spreadable compound 102 may be applied directly onto partially dried layers without the need for sanding, thereby enabling rapid multi-coat application [Step 210]. Finally, the treated surface is allowed to cure under ambient conditions, producing a smooth, uniform finish with reduced airborne particulate release and no VOC-related health hazards [Step 212].

Following introduction of the additive 100 into the spreadable compound 102, the additive 100 may initiate a molecular-level transformation that alters performance characteristics beyond conventional material behavior. The spreadable compound 102 may exhibit wet-on-wet layering capability, wherein a subsequently applied wet layer activates a previously applied partially cured layer, enabling compression, intermixing, and permeation between layers. This interaction may produce a unified, continuous coating structure rather than discrete stratified layers as observed in traditional spreadable compounds. The spreadable compound 102 may further support rehydration for a period of up to approximately 24 hours depending on environmental conditions, allowing additional manipulation and refinement after initial application. The interaction between layers may produce a stronger bond through a melting or fusing effect, thereby increasing compressive strength and structural integrity of the finished surface.

The additive 100 may further eliminate the requirement for sanding between applied layers of the spreadable compound 102. The spreadable compound 102 may be refined through rehydration and mechanical retooling using application implements such as but not limited to trowels, blades, sponges, etc., thereby reducing or eliminating airborne particulate generation associated with sanding processes. Final surface finishing may be achieved through rehydration and smoothing techniques, although optional sanding may still be performed if desired.

The additive 100 may enable post-application reactivation of the spreadable compound 102 following partial curing. The spreadable compound 102 may be reactivated through the application of water or a finishing agent, thereby restoring workability and allowing continued surface manipulation. This reactivation capability may extend the workable time window of the spreadable compound 102 beyond that of traditional materials, supporting delayed finishing adjustments and refinement.

A rehydration-based surface finishing process may be enabled, wherein traditional sanding is replaced by refinement through rehydration and mechanical smoothing. Following partial curing, the spreadable compound 102 may be rehydrated and subsequently smoothed or polished using standard tools such as but not limited to trowels, blades, sponges, etc. This approach may reduce labor, dust generation, and cleanup requirements while producing a refined surface finish.

Repeated applications of the spreadable compound 102 treated with the additive 100 may result in a structurally integrated coating. Multiple applied layers may merge into a cohesive mass through interlayer activation and bonding, thereby reducing the presence of discrete layer boundaries and improving durability, adhesion, and uniformity of the finished surface.

The spreadable compound 102 treated with the additive 100 may exhibit resistance to microbial growth such as mold and mildew. Such resistance may be attributed to reduced moisture retention, surface densification, chemical composition, or any combination thereof, thereby enhancing environmental durability and suitability for use in moisture-prone environments.

The additive 100 and associated methods may be characterized by a combination of material formulation, application sequence, timing, and reactivation processes that collectively produce enhanced performance characteristics, such as but not limited to extended workability, reactivation capability, reduced need for sanding, improved layer integration, and enhanced environmental resistance.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “joint compound additive” and “additive” are interchangeable and refer to the joint compound additive 100 of the present invention.

Notwithstanding the foregoing, the joint compound additive 100 of the present invention and its various components can be of any suitable size and configuration as is known in the art without affecting the overall concept of the invention, provided that they accomplish the above-stated objectives. One of ordinary skill in the art will appreciate that the size, configuration, and material of the joint compound additive 100 as shown in the FIGS. are for illustrative purposes only, and that many other sizes and shapes of the joint compound additive 100 are well within the scope of the present disclosure. Although the dimensions of the joint compound additive 100 are important design parameters for user convenience, the joint compound additive 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A joint compound additive comprising:
a fractured metal oxide;
a glass; and
a catalyzed quick-set joint compound powder.

2. The joint compound additive of claim 1, wherein the fractured metal oxide is present in a range between 0.5 and 40 ounces by weight.

3. The joint compound additive of claim 1, wherein the glass is present in a range between 0.5 and 40 ounces by weight.

4. The joint compound additive of claim 3, wherein the glass is a glass bead.

5. The joint compound additive of claim 3, wherein the glass is a crushed glass.

6. The joint compound additive of claim 1, further comprising a mineral aggregate.

7. The joint compound additive of claim 1, wherein the catalyzed quick-set joint compound powder is present in a range between 0.5 and 40 ounces.

8. The joint compound additive of claim 1, wherein the glass bead is comprised of a mesh size between 100 and 132.

9. A stabilized joint compound comprising:
a spreadable compoundable;
a fractured metal oxide;
a glass; and
a catalyzed quick-set joint compound powder.

10. The stabilized joint compound of claim 9, wherein the joint compound is comprised of a combination of two or more of a calcium carbonate, a talc, a mica, a perlite, an expanded silica, a vinyl acetate polymer, a clay, a bentonite, an attapulgite, a water, a calcium sulfate hemihydrate, a preservative, a mildewcide, a glass, a microsphere, or a fractured metal oxide.

11. The joint compound additive of claim 9, wherein the fractured metal oxide is present in a range between . 5 and 40 ounces.

12. The joint compound additive of claim 10, wherein the glass is a glass bead.

13. The joint compound additive of claim 10, wherein the glass is a crushed glass.

14. The joint compound additive of claim 10, wherein the glass is present in a range between 0.5 and 40 ounces.

15. The joint compound additive of claim 10, wherein the catalyzed quick-set joint compound powder is present in a range between 0.5 and 40 ounces.

16. The joint compound additive of claim 12, wherein the glass bead is comprised of a mesh size between 100 and 240.

17. The joint compound additive of claim 10, further comprising a mineral aggregate.

18. A method of using a joint compound additive, the method comprising the following steps:
providing a joint compound additive comprised of a fractured metal oxide, a glass, and a catalyzed quick-set joint compound powder;
introducing the joint compound additive into a joint compound;
mixing the joint compound additive with the joint compound to initiate a chemical transformation;
applying a stabilized joint compound that results from the mixing to a surface in a layer; and
applying an additional layer of the stabilized joint compound directly onto the layer when the layer is partially dried without sanding.

19. The method of using a joint compound additive of claim 18, wherein the joint compound is in a box or a bucket form.

20. The method of using a joint compound additive of claim 18, wherein the joint compound is in a bag form.
